(19) United States
(12) Patent Application Publication
(10) Pub. No.: US 2024/0065179 A1
(43) Pub. Date: Feb. 29, 2024

(54) Pot Assembly

(71) Applicant: Hill Street Companies LLC, Oxford, MI (US)

(72) Inventor: Christopher Wasko, Auburn Hills, MI (US)

(21) Appl. No.: 17/897,802

(22) Filed: Aug. 29, 2022

(51) Int. Cl. A01G 9/02

(52) U.S. Cl. CPC A01G 9/028

(57) ABSTRACT

A pot assembly is designed to grow a plant through multiple growth stages. The pot assembly includes a base surface. At least one sidewall extends up from the base surface to a top edge defining a total volume within the at least one sidewall above the base surface. The at least one sidewall includes at least one slot extending across a portion of the at least one sidewall between the base surface and the top edge. A at least one divider is removably installed within the slot dividing the volume into first and second volume parts. The at least one divider is removable at an appropriate time in the life of the plant to allow the plant's roots to expand into a new space without having to repot the plant.

### BACKGROUND OF THE INVENTION

### 1. Field of the Invention

The invention relates to pots for plants. More particularly, the invention relates to a pot assembly for plants allowing for the maximization of growth for a plant while it is planted in the pot assembly.

### 2. Description of the Related Art

Often, plants are grown in pots. As the plant continues to grow within the pot, the plant becomes root bound. While it is desirable for a plant to become root bound, the plant cannot continue to grow and/or develop if it continues to be in a root-bound condition. Currently, the only way to remedy the situation of having a root bound plant is to remove the plant from the pot and replant the plant in a larger pot. This creates inventory issues for nurseries and retail consumers and is labor-intensive.

### SUMMARY OF THE INVENTION

A pot assembly is designed to grow a plant through multiple growth stages. The pot assembly includes a base surface. At least one sidewall extends up from the base surface to a top edge defining a total volume within the at least one sidewall above the base surface. The at least one sidewall includes a slot extending across a portion of the at least one sidewall between the base surface and the top edge. A at least one divider is removably installed within the slot dividing the volume into first and second volume parts.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a side view of one embodiment of a pot assembly with a plant growing in soil within a first volume part of thereof;

FIG. 2 is a perspective view of one embodiment of the assembly with a at least one divider partially filled out;

FIG. 3 is a side view of the embodiment of FIG. 1 with the plant growing in soil within the first and second volume parts of the pot assembly;

FIG. 4 is a side view of the pot assembly with the at least one divider partially removed; and

FIG. 5 is a top view of the at least one divider removed from the pot assembly.

### DETAILED DESCRIPTION OF THE INVENTION

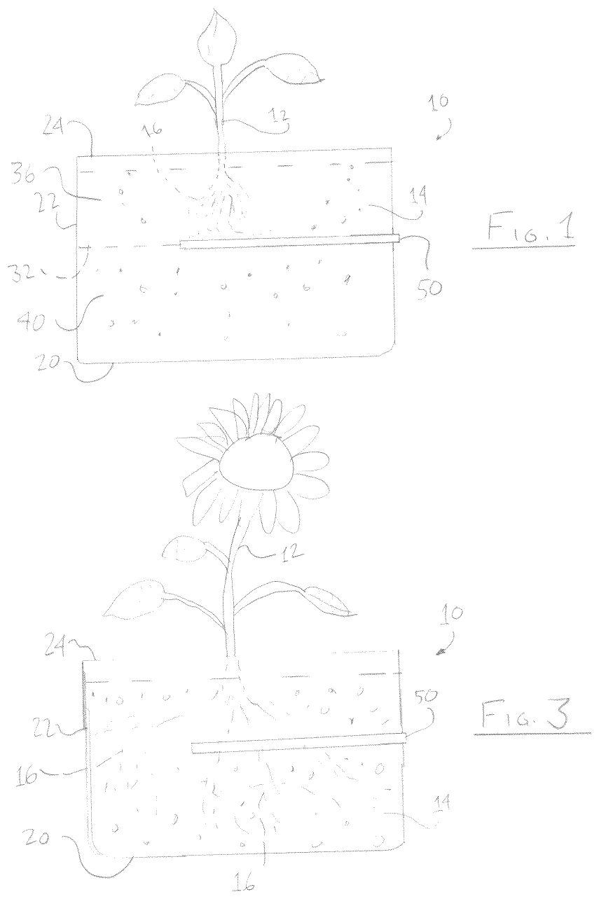

Referring to FIG. 1, one embodiment of a pot assembly is generally indicated at 10. The pot assembly 10 is used for growing a plant 12 in a growing medium 14. Roots 16 of the plant 12 and a top surface 18 of the growing medium 14 are shown in phantom. A non-exhaustive list of possible growing mediums 14 include, but is not limited to, soil, potting mix, mulch, and coconut husks.

The pot assembly 10 includes a base surface 20. The base surface 20 is generally flat and defines a bottom of the pot assembly 10. It should be appreciated by those skills and the arts that the pot assembly 10 may include a base surface that is not substantially flat or may include a catch basin/plate (not shown) as is known in the arts to catch excess water that drains from the growing medium 14.

The pot assembly 10 includes at least one sidewall 22 that extends up from the base surface 20. In the embodiment shown, there are four sidewalls 22. However, if the pot assembly 10 has a circular cross section, there will only be one sidewall 22. The at least one sidewall 22 extends up from the base surface 20 to a top edge 24. The top edge 24 defines an opening 26 (shown in FIG. 2) for the pot assembly 10 allowing the plant 12 to grow above it. In many cases, the plant 12 receives water and fertilizer (neither shown) via the opening 26.

The at least one sidewall 22 includes at least one slot 30 cut into the at least one sidewall 22. The at least one slot 30 extends across a portion of the at least one sidewall 22. The at least one slot 30 is formed within the at least one sidewall 22 between the base surface 20 and the top edge 24. In the embodiment shown, the at least one slot 30 extends parallel to the base surface 20 and the top edge 24 of the pot assembly 10. It is not imperative that the planes defined by each of these elements 20, 24, 30 are parallel as they are shown in the Figures. The ratio of the distance between the base surface 20 and the at least one slot 30 with respect to the distance between the at least one slot 30 and the top edge 24 may be defined by the characteristics of the plant 12. Alternatively, as is shown in the Figures, the at least one slot 30 is roughly equidistant between the base surface 20 and the top edge 24. It should be appreciated by those skilled in the art that more than one slot 30 will require the slots 30 to be at different elevations with respect to the base surface 20.

The at least one slot 30 extends through over 50% of the at least one sidewall 22. As an alternative to having the at least one slot 30 extend through over half of the at least one sidewall 22 is to form a channel on the inside surface of the at least one side wall 22. The channel would minimize the at least one slot 30 to a single side wall 22 (in the case where the pot assembly 10 is cubic or rectangular in shape or 50% of the at least one side wall 22 when the pot assembly has a circular cross section when viewed from above.

The pot assembly 10 includes a at least one divider 32. The at least one divider 32 is removably insertable into the at least one slot 30. The at least one divider 32 is designed to have a periphery that matches the periphery created by the at least one sidewall 22. The at least one divider 32 divides a total volume 34 of the pot assembly 10 into a first volume part 36 and a second volume part 40. For purposes of perspective, the first volume part 36 is above or on top of the second volume part 40.

Both the first 36 and second 40 volume parts are filled with growing medium 14. The at least one divider 32 prevents the plant 12 from extending its roots into the second volume part 40 until after the plant 12 has matured and is ready to successfully occupy the second volume part 40, which will allow the plant 12 to grow through a next stage of its life. This typically happens after a root bound plant 12 is provided access to more soil to grow.

In one embodiment, the growing medium 14 in the second volume part 40 includes different elements or different amounts of elements than the growing medium 14 in the first volume part 36. In many instances when the plant 12 is a blooming plant, the plant 12 requires different nutrients at different stages of its life and the composition of the growing medium 14 changes between the two volume parts 36, 40 to accommodate these differences. Some plants 12 that do not bloom may not need different growing mediums 14 above and below the at least one divider 32.

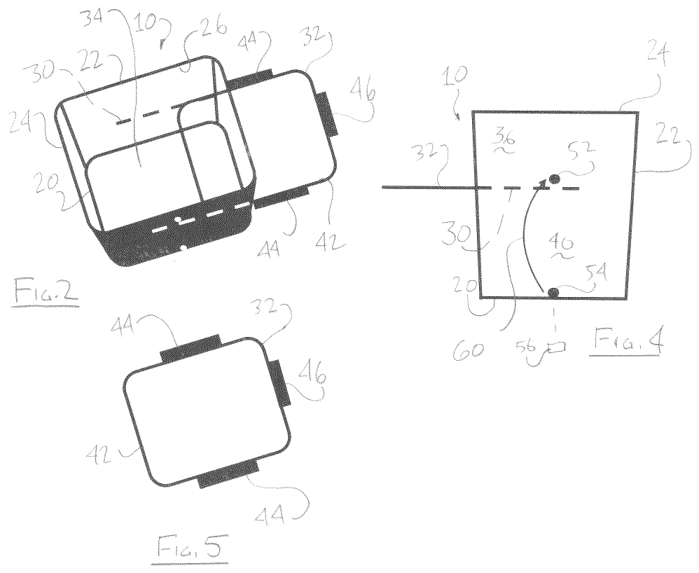

The at least one divider 32 defines a at least one divider edge 42, which is the periphery of the at least one divider 32. The at least one divider edge 42 includes at least a pair of slot flanges 44 that extend out from the at least one divider 32 coplanarly therewith. The slot flanges 44 are received by the at least one slot 30 as the at least one divider 32 moves between its embedded position (shown in FIG. 1) and its extracted position (shown in FIGS. 3 and 5) with intermediate positions disposed therebetween (shown in FIGS. 2 and 4). The at least one divider 32 also includes a tab or handle 46 that extends out from the at least one divider edge 42 and allows someone the ability to grab hold of the handle 46 to remove the at least one divider 32 from the pot assembly 10.

In the embodiment discussed above with the interior of the at least one sidewall 22 having a channel, the slot flanges 44 would not be necessary.

A seal 50 is used to seal the at least one slot 30 so that growing medium 14, roots 16 and water (not shown) do not extend out past the at least one sidewall 22. The seal 50 may either be secured to the at least one divider edge 42 or directly to the at least one slot 30. In one embodiment the seal 50 is an elastic band that extends around the exterior of the at least one sidewall 22.

The pot assembly 10 includes first 52 and second 54 drainage openings associated with the first 36 and second 40 volume parts, respectively. The pot assembly 10 also includes a drain plug 56, which is inserted into the second drainage opening 54 when the at least one divider 32 is inserted into the at least one sidewall 22. The first drainage opening 52 is left unplugged so that excess water may drain from the first drainage opening 52 when the plant 12 is growing with the at least one divider 32 in place.

When the at least one divider 32 is removed, the plug 56 is removed and moved up to the first drainage opening 52 as indicated by arrow 60. The plug 56 plugs the first drainage opening 52 to force water down into the second volume part 40. With the second drainage opening 54 now open, excess water can drain out of the pot assembly 10 therethrough.

Once the at least one divider 32 is removed from the at least one sidewall 22, the seal 50 is reinserted into the at least one slot 30 in the at least one sidewall 22. This, in combination with the plug 56 being inserted into the first drainage opening 52, seals the pot assembly 10 such that the plant 12 can utilize the total volume 34 of the pot assembly 10.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A pot assembly for growing a plant through multiple growth stages, said pot assembly comprising:
a base surface;
at least one sidewall extending up from said base surface to a top edge defining a total volume of said pot assembly within said at least one side wall above said base surface, said at least one sidewall including a slot extending across a portion of said at least one sidewall between said base surface and said top edge; and
a at least one divider removably installed within said slot dividing said total volume into first and second volume parts.

2. A pot assembly as set forth in claim 1 wherein said at least one divider defines an at least one divider edge.

3. A pot assembly as set forth in claim 2 wherein said at least one divider includes a seal extending along a portion of said at least one divider edge to prevent contents within said first volume part from passing therethrough.

4. A pot assembly as set forth in claim 3 wherein said seal is removable from said at least one divider to reseal said slot when said at least one divider is removed from said slot.

5. A pot assembly as set forth in claim 1 including first and second drainage holes wherein said first drainage hole is between said slot and said top edge and said second drainage hole is between said base surface and said slot.

6. A pot assembly as set forth in claim 5 including a plug removably secured within said second drainage hole.

7. A pot assembly as set forth in claim 1 including a growing medium disposed within said total volume.

8. A pot assembly as set forth in claim 7 wherein said growing medium includes a first mixture of growing medium above said at least one divider and a second mixture of growing medium below said at least one divider.

9. A method for growing a plant in a pot assembly filled with a growing medium having a base surface and at least one sidewall with at least one slot extending therethrough and at least one divider inserted into the at least one slot creating a first volume of growing medium above the at least one divider and a second volume of growing medium below the at least one divider, the method comprising the steps of:
growing a plant in the first volume of soil until it is rootbound; and
removing the at least one divider after the plant is rootbound providing access to the second volume of growing medium to allow the plant to continue growing.

10. A method as set forth in claim 9 including the step of sealing the slot after the at least one divider is removed to prevent roots and moisture from exiting the pot assembly through the slot.
